(19) United States
(12) Patent Application Publication
(10) Pub. No.: US 2018/0337903 A1
(43) Pub. Date: Nov. 22, 2018

(54) WIRELESS LAN ACCESS POINT AND ENCRYPTION KEY SHARING METHOD

(71) Applicant: Allied Telesis Holdings K.K., Tokyo (JP)

(72) Inventor: Masafumi Utsugi, Tokyo (JP)

(21) Appl. No.: 15/979,944

(22) Filed: May 15, 2018

(30) Foreign Application Priority Data
May 17, 2017 (JP) 2017-98104

(51) Int. Cl. H04L 29/06; H04W 12/04; H04W 48/14; H04W 84/12

(52) U.S. Cl. CPC H04L 63/062; H04W 84/12; H04W 48/14; H04W 12/04

(57) ABSTRACT

A wireless LAN access point communicates wirelessly with a wireless LAN communication terminal using an encryption key. The wireless LAN access point includes a proximate access point detecting section and an encryption key transmitting section. The proximate access point detecting section detects a proximate wireless LAN access point arranged at a short distance from the wireless LAN access point. The encryption key transmitting section transmits the encryption key to the proximate wireless LAN access point.

### CROSS REFERENCE TO RELATED APPLICATION

The present application claims priority under 35 U.S.C. § 119 to Japanese Application No. 2017-98104 filed May 17, 2017, the entire content of which is incorporated herein by reference.

### BACKGROUND OF THE INVENTION

### Field of the Invention

The present invention relates to high-speed roaming.

### Description of the Related Art

A wireless LAN (Local Area Network) has conventionally been known having multiple wireless LAN access points. In such a wireless LAN, a wireless LAN station communicates with one of the wireless LAN access points A. During this, when the wireless LAN station moves away from the wireless LAN access point A, the communication quality decreases. In this case, the wireless LAN station may come close to one of the other wireless LAN access points B. Communication with the wireless LAN access point B can thus prevent the communication quality from decreasing. Such a change in the wireless LAN access point with which the wireless LAN station communicates is called roaming (see Abstract of Japanese Unexamined Patent Application Publication No. 2010-93360, for example).

Upon roaming by a wireless LAN station, an authentication server conducts IEEE 802.1x-based authentication and distributes a PMK (Pairwise Master Key) to the wireless LAN station and the corresponding wireless LAN access points. Such IEEE 802.1x-based authentication and PMK distribution takes time and thereby delays the roaming.

It is hence possible to contemplate conducting pre-authentication defined in IEEE 802.11i for high-speed roaming. In the pre-authentication, when the wireless LAN station detects a roamable wireless LAN access point therearound, the authentication server conducts IEEE 802.1x-based authentication and issues/distributes a PMK before roaming to the wireless LAN access point detected. Accordingly, upon roaming, neither IEEE 802.1x-based authentication nor PMK issue/distribution is required, whereby high-speed roaming can be achieved.

### SUMMARY OF THE INVENTION

In the pre-authentication defined in IEEE 802.11i, however, authentication is conducted and a PMK is issued/distributed for each wireless LAN access point detected, which causes an authentication server to be highly loaded.

It is hence an object of the present invention to achieve high-speed roaming while reducing the load on an authentication server.

According to the present invention, a wireless LAN access point that communicates wirelessly with a wireless LAN communication terminal using an encryption key, includes: a proximate access point detecting section that detects a proximate wireless LAN access point arranged at a short distance from the wireless LAN access point; and an encryption key transmitting section that transmits the encryption key to the proximate wireless LAN access point.

The thus constructed wireless LAN access point communicates wirelessly with a wireless LAN communication terminal using an encryption key. A proximate access point detecting section detects a proximate wireless LAN access point arranged at a short distance from the wireless LAN access point. An encryption key transmitting section transmits the encryption key to the proximate wireless LAN access point.

According to the wireless LAN access point of the present invention, the encryption key may be used even when the wireless LAN communication terminal starts communicating wirelessly with the proximate wireless LAN access point in place of the wireless LAN access point.

According to the wireless LAN access point of the present invention, the encryption key may be a Pairwise Master Key.

According to the wireless LAN access point of the present invention, the proximate access point detecting section may detect the proximate wireless LAN access point based on a beacon transmitted from another wireless LAN access point.

According to the present invention, the wireless LAN access point may include a transmission availability determining section that determines whether or not the encryption key transmitting section can transmit the encryption key.

According to the wireless LAN access point of the present invention, the transmission availability determining section may determine that the encryption key can be transmitted if at least one SSID of the wireless LAN access point and an authentication method for use of the at least one SSID and at least one SSID of the proximate wireless LAN access point and an authentication method for use of the at least one SSID are, respectively, the same.

According to the wireless LAN access point of the present invention, the encryption key transmitting section may transmit the encryption key through a LAN cable to the proximate wireless LAN access point.

According to the present invention, an encryption key sharing method using a wireless LAN access point that communicates wirelessly with a wireless LAN communication terminal using an encryption key, includes: a proximate access point detecting step that detects a proximate wireless LAN access point arranged at a short distance from the wireless LAN access point; and an encryption key transmitting step that transmits the encryption key to the proximate wireless LAN access point.

### BRIEF DESCRIPTION OF DRAWINGS

FIG. 1 outlines the positional relationship between communication devices such as wireless LAN access points 10a in a wireless LAN system according to an embodiment of the present invention;

FIG. 2 is a functional block diagram showing the network configuration of the wireless LAN system according to the embodiment of the present invention;

FIG. 3 is a functional block diagram showing the configuration of the wireless LAN access point 10a;

FIG. 4 is a functional block diagram showing the configuration of the proximate wireless LAN access point 10b;

FIG. 5 is a flow chart showing an operation of the wireless LAN system according to the embodiment of the present invention during initial connection;

FIG. 6 is a flow chart showing an operation of the wireless LAN system according to the embodiment of the present invention during PMK sharing;

FIG. 7 is a flow chart showing an operation of the wireless LAN system according to the embodiment of the present invention during roaming;

FIG. 8 is a functional block diagram of the wireless LAN system according to the embodiment of the present invention with the operation of the wireless LAN system during the initial connection written therein;

FIG. 9 is a functional block diagram of the wireless LAN system according to the embodiment of the present invention with the operation of the wireless LAN system during the PMK sharing written therein; and

FIG. 10 is a functional block diagram of the wireless LAN system according to the embodiment of the present invention with the operation of the wireless LAN system during the roaming written therein.

### DESCRIPTION OF THE PREFERRED EMBODIMENTS

Hereinafter, a description will be given of an embodiment of the present invention referring to drawings.

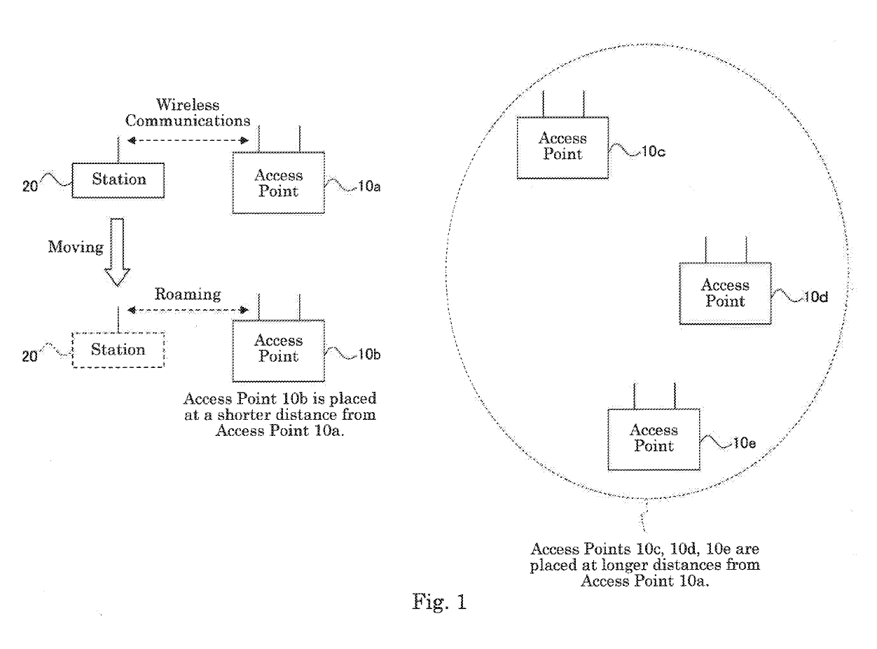

FIG. 1 outlines the positional relationship between communication devices such as wireless LAN access points l0a in a wireless LAN system according to an embodiment of the present invention. It is noted that in the drawings, the prefix “wireless LAN” is omitted to refer to access points 10a, 10b, 10c, 10d, 10e, and a station 20.

The wireless LAN system according to the embodiment of the present invention includes wireless LAN access points 10a, 10b, 10c, 10d, 10e, a wireless LAN station (wireless LAN communication terminal) 20, an authentication server 30, and a LAN cable 40. However, the authentication server 30 and the LAN cable 40 are not shown in FIG. 1.

The wireless LAN access point 10a communicates wirelessly with the wireless LAN station (wireless LAN communication terminal) 20 using an encryption key. It is noted that the encryption key (e.g. Pairwise Master key (hereinafter referred to as “PMK”)) is used even when the wireless LAN station 20 starts communicating (roaming) wirelessly with the wireless LAN access point (proximate wireless LAN access point) 10b in place of the wireless LAN access point 10a.

However, data communicated wirelessly between the wireless LAN access point 10a and the wireless LAN station 20 is encrypted not directly using the PMK but using a key that is generated dynamically from the PMK. PMK is thus used indirectly for wireless communications. In any case, the fact remains that the wireless LAN access point 10a communicates with wirelessly the wireless LAN station 20 using an encryption key (PMK).

The wireless LAN access point (proximate wireless LAN access point) 10b is placed at a shorter distance from the wireless LAN access point 10a.

The wireless LAN access points 10c, 10d, 10e are placed at longer distances from the wireless LAN access point 10a.

The wireless LAN station (wireless LAN communication terminal) 20 communicates wirelessly with the wireless LAN access point 10a using an encryption key. It is contemplated that after moving, the wireless LAN station 20 starts communicating (roaming) wirelessly with the wireless LAN access point 10b, which is closer to the wireless LAN access point 10a, in place of the wireless LAN access point 10a. It is noted that the wireless LAN access points 10c, 10d, 10e, which are farther from the wireless LAN access point 10a, are less thought to communicate with the wireless LAN station 20. That is, the proximate wireless LAN access point 10b, which is closer to the wireless LAN access point 10a, is likely to be a roaming target.

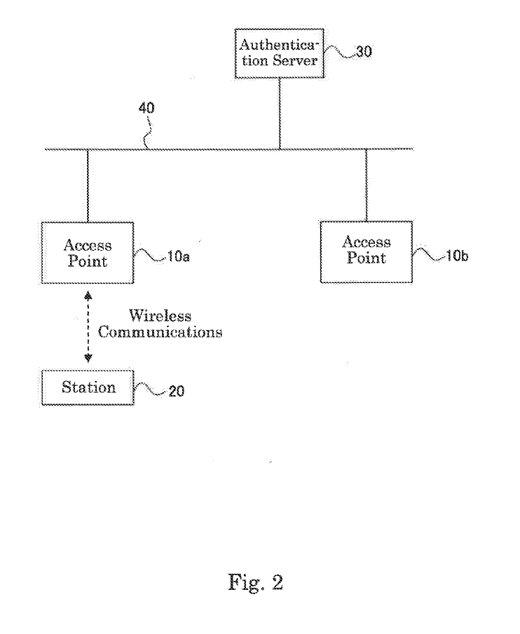

FIG. 2 is a functional block diagram showing the network configuration of the wireless LAN system according to the embodiment of the present invention. In FIG. 2, the wireless LAN access points 10a, 10b, the wireless LAN station 20, the authentication server 30, and the LAN cable 40 included in the wireless LAN system according to the embodiment of the present invention are shown, while the wireless LAN access points 10c, 10d, 10e are not shown.

The wireless LAN access points 10a, 10b and the authentication server 30 are connected via the LAN cable 40 and switches not shown. The wireless LAN access point 10a and the wireless LAN station 20 are not connected through a wire but communicate wirelessly with each other.

The authentication server 30 receives a request for authentication from the wireless LAN access point 10a and then prepares and transmits a PMK to the wireless LAN access point 10a and the wireless LAN station 20. The authentication server 30 is a RADIUS (Remote Authentication Dial In User Service) server that conducts IEEE 802.1x-based authentication for the wireless LAN access point 10aand the wireless LAN station 20.

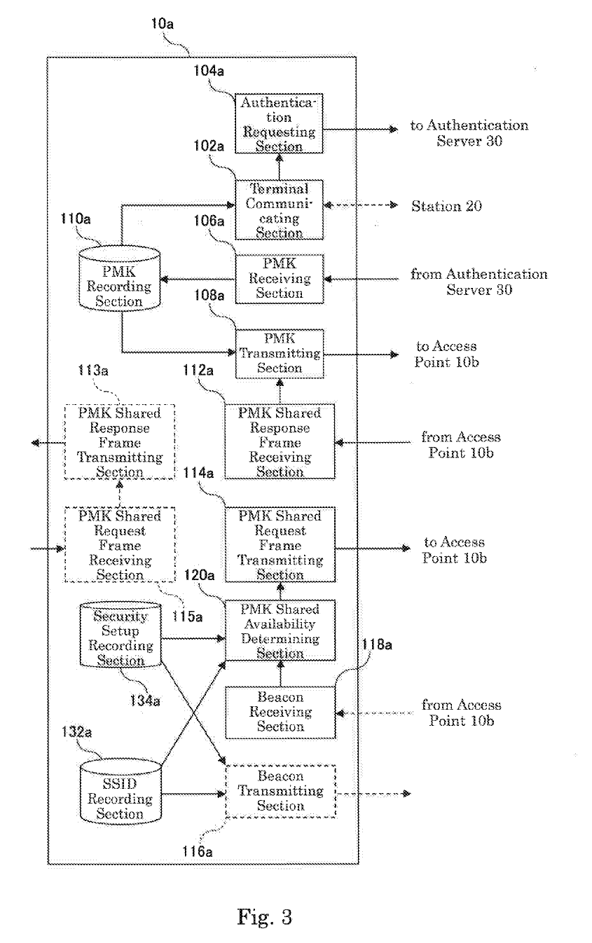

FIG. 3 is a functional block diagram showing the configuration of the wireless LAN access point 10a. The wireless LAN access point 10a has a terminal communicating section 102a, an authentication requesting section 104a, a PMK receiving section 106a, a PMK transmitting section (encryption key transmitting section) 108a, a PMK recording section 110a, a PMK shared response frame receiving section 112a, a PMK shared request frame transmitting section 114a, a beacon transmitting section 116a, a beacon receiving section (proximate access point detecting section) 118a, a PMK shared availability determining section (transmission availability determining section) 120a, an SSID recording section 132a, a security setup recording section 134a, a PMK shared response frame transmitting section 113a, and a PMK shared request frame receiving section 115a.

The terminal communicating section 102a communicates wirelessly with the wireless LAN station 20. It is noted that the terminal communicating section 102a communicates wirelessly with the wireless LAN station 20 indirectly using a PMK recorded in the PMK recording section 110a. That is, data communicated between the terminal communicating section 102a and the wireless LAN station 20 is encrypted using a key that is generated dynamically from the PMK.

The authentication requesting section 104a makes a request to the authentication server 30 for authentication of the wireless LAN station 20. The request is transferred through the LAN cable 40 to the authentication server 30.

The PMK receiving section 106a receives a PMK transmitted from the authentication server 30 through the LAN cable 40 and writes it into the PMK recording section 110a.

The PMK transmitting section (encryption key transmitting section) 108a transmits a PMK to the wireless LAN access point (proximate wireless LAN access point) 10b. It is noted that the PMK transmitting section 108a transmits a PMK through the LAN cable 40 to the wireless LAN access point 10b. In this regard, the PMK transmitting section 108a transmits a PMK only when receiving a notice of reception of a PMK shared response frame from the PMK shared response frame receiving section 112a. However, if a PMK has already been transmitted to the wireless LAN access point 10b, it is not required to transmit a further PMK to the wireless LAN access point 10b.

The PMK recording section 110a records a PMK.

The SSID recording section 132a records the SSID (Service Set Identifier) of the wireless LAN access point 10a. In this regard, SSID is an access point identifier defined in IEEE 802.11.

The security setup recording section 134a records an authentication method (e.g. WPA Personal, WPA Enterprise, or WPA2 Enterprise) employed when the wireless LAN access point 10a communicates wirelessly with the wireless LAN station 20.

The beacon transmitting section 116a reads an SSID out of the SSID recording section 132a and reads an authentication method out of the security setup recording section 134a. The beacon transmitting section 116a further transmits a beacon with the read SSID and authentication method recorded therein. However, the beacon transmitting section 116a may not be employed in this embodiment.

The beacon receiving section (proximate access point detecting section) 118a detects a proximate wireless LAN access point placed at a shorter distance from the wireless LAN access point 10a. In this embodiment, the proximate wireless LAN access point is the wireless LAN access point 10b and not the wireless LAN access points 10c, 10d, 10e (see FIG. 1).

The beacon receiving section 118a detects a proximate wireless LAN access point based on a beacon transmitted from the wireless LAN access point 10b, 10c, 10d, or 10e, which is different from the wireless LAN access point 10a. For example, if the received beacon has a strength equal to or greater than a predetermined threshold value, the beacon receiving section 118a determines the wireless LAN access point that has transmitted the beacon as a proximate wireless LAN access point.

It is noted that a beacon is recorded with the SSID and the authentication method of the wireless LAN access point that has transmitted the beacon. The beacon receiving section 118a reads the SSID and the authentication method out of a beacon that is received from the detected proximate wireless LAN access point and provides them to the PMK shared availability determining section (transmission availability determining section) 120a.

In this embodiment, for example, since the proximate wireless LAN access point is the wireless LAN access point 10b, the beacon receiving section 118a reads the SSID and the authentication method of the wireless LAN access point 10b out of a beacon and provides them to the PMK shared availability determining section (transmission availability determining section) 120a.

The PMK shared availability determining section (transmission availability determining section) 120a determines whether or not the encryption key transmitting section 108a can transmit an encryption key (PMK). Specifically, the PMK shared availability determining section (transmission availability determining section) 120a determines that the PMK can be transmitted if at least one SSID of the wireless LAN access point 10a and an authentication method for use of the SSID and at least one SSID of the proximate wireless LAN access point 10b and an authentication method for use of the SSID are, respectively, the same.

“At least one SSID and an authentication method for use of the SSID” will hereinafter be described.

If only one SSID is set at a wireless LAN access point, only one authentication method is also set for use of the SSID. The thus set only one SSID and authentication method are therefore “at least one SSID and an authentication method for use of the SSID”.

If multiple SSIDs are set at a wireless LAN access point (hereinafter referred to as “multi-SSID”), an authentication method is set correspondingly for each of the SSIDs. In this case, “at least one SSID and an authentication method for use of the SSID” are one or more of the multiple set SSIDs and authentication methods set correspondingly for the respective SSIDs.

For example, it is assumed that both the wireless LAN access point 10a and the proximate wireless LAN access point 10b are multi-SSID. It is further assumed that the wireless LAN access point 10a has SSIDs and authentication methods such that “one SSID is AAA and one authentication method is WPA Enterprise” and “the other SSID is BBB and the other authentication method is WPA Personal” and the proximate wireless LAN access point 10b has SSIDs and authentication methods such that “one SSID is AAA and one authentication method is WPA Enterprise” and “the other SSID is CCC and the other authentication method is WPA Personal”. In this case, “one SSID is AAA and one authentication method is WPA Enterprise” is common to both the wireless LAN access points. Accordingly, this corresponds to the case where at least one SSID of the wireless LAN access point 10a and an authentication method for use of the SSID and at least one SSID of the proximate wireless LAN access point 10b and an authentication method for use of the SSID are, respectively, the same.

In more detail, the PMK shared availability determining section 120a reads SSIDs and authentication methods of the wireless LAN access point 10a out of the SSID recording section 132a and the security setup recording section 134a. The PMK shared availability determining section 120a receives SSIDs and authentication methods of the proximate wireless LAN access point 10b from the beacon receiving section 118a. The PMK shared availability determining section 120a further determines that the PMK can be transmitted if at least one SSID of the wireless LAN access point 10a and an authentication method for use of the SSID and at least one SSID of the proximate wireless LAN access point 10b and an authentication method for use of the SSID are, respectively, the same, while determines that the PMK cannot be transmitted if not the same.

The PMK shared availability determining section 120a, when determines that the PMK can be transmitted, instructs the PMK shared request frame transmitting section 114a to transmit a PMK shared request frame.

The PMK shared request frame transmitting section 114a, when receives from the PMK shared availability determining section 120a an instruction to transmit a PMK shared request frame (if it is determined that the PMK can be transmitted), transmits the PMK shared request frame through the LAN cable 40 to the proximate wireless LAN access point 10b.

The PMK shared response frame receiving section 112a receives a PMK shared response frame from the proximate wireless LAN access point 10b through the LAN cable 40 and notifies the PMK transmitting section 108a of the reception of the PMK shared response frame.

The PMK shared response frame transmitting section 113a and the PMK shared request frame receiving section 115a will be described below.

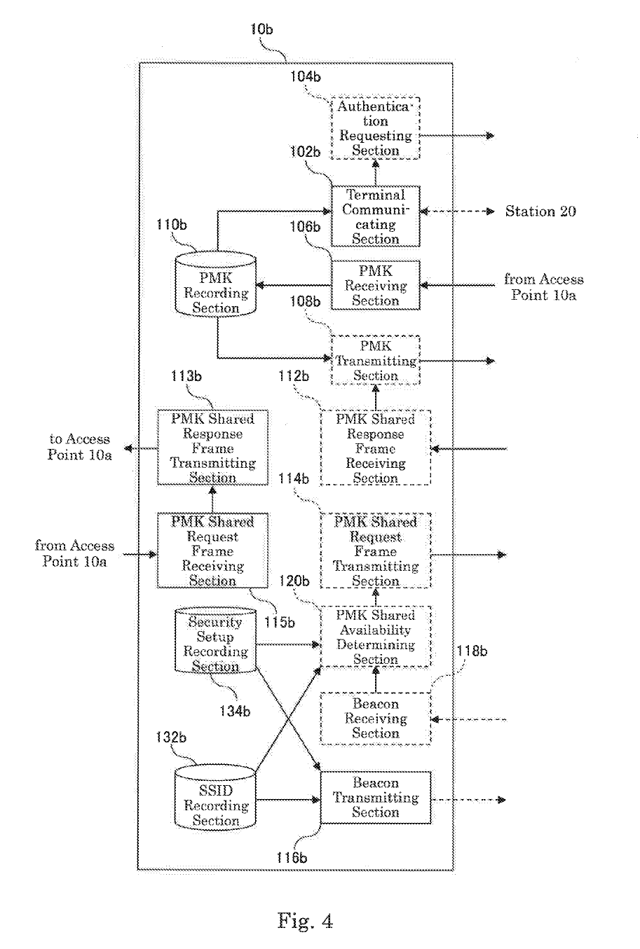

FIG. 4 is a functional block diagram showing the configuration of the proximate wireless LAN access point 10b. The proximate wireless LAN access point 10b has a terminal communicating section 102b, an authentication requesting section 104b, a PMK receiving section 106b, a PMK transmitting section (encryption key transmitting section) 108b, a PMK recording section 110b, a PMK shared response frame receiving section 112b, a PMK shared request frame transmitting section 114b, a beacon transmitting section 116b, a beacon receiving section (proximate access point detecting section) 118b, a PMK shared availability determining section (transmission availability determining section) 120b, an SSID recording section 132b, a security setup recording section 134b, a PMK shared response frame transmitting section 113b, and a PMK shared request frame receiving section 115b.

The terminal communicating section 102b, the authentication requesting section 104b, the PMK receiving section 106b, the PMK transmitting section (encryption key transmitting section) 108b, the PMK recording section 110b, the PMK shared response frame receiving section 112b, the PMK shared request frame transmitting section 114b, the beacon transmitting section 116b, the beacon receiving section (proximate access point detecting section) 118b, the PMK shared availability determining section (transmission availability determining section) 120b, the SSID recording section 132b, and the security setup recording section 134b will not be described because they function in the same manner, respectively, as the terminal communicating section 102a, the authentication requesting section 104a, the PMK receiving section 106a, the PMK transmitting section (encryption key transmitting section) 108a, the PMK recording section 110a, the PMK shared response frame receiving section 112a, the PMK shared request frame transmitting section 114a, the beacon transmitting section 116a, the beacon receiving section (proximate access point detecting section) 118a, the PMK shared availability determining section (transmission availability determining section) 120a, the SSID recording section 132a, and the security setup recording section 134a.

However, in this embodiment, the authentication requesting section 104b, the PMK transmitting section 108b, the PMK shared response frame receiving section 112b, the PMK shared request frame transmitting section 114b, the beacon receiving section 118b, and the PMK shared availability determining section 120b may not be employed.

The PMK receiving section 106b also receives a PMK from the wireless LAN access point l0a through the LAN cable 40.

The PMK shared request frame receiving section 115b receives a PMK shared request frame from the wireless LAN access point 10a through the LAN cable 40 and notifies the PMK shared response frame transmitting section 113b of the reception. The PMK shared request frame receiving section 115a (see FIG. 3) also functions in the same manner as the PMK shared request frame receiving section 115b, which may not be employed in this embodiment.

The PMK shared response frame transmitting section 113b, when receives from the PMK shared request frame receiving section 115b a notice of reception of the PMK shared request frame, transmits a PMK shared response frame through the LAN cable 40 to the wireless LAN access point 10a. The PMK shared response frame transmitting section 113a (see FIG. 3) also functions in the same manner as the PMK shared response frame transmitting section 113b, which may not be employed in this embodiment.

An operation according to the embodiment of the present invention will next be described.

The operation according to the embodiment of the present invention can be classified roughly into the following three steps: (1) Initial connection, (2) PMK sharing, and (3) Roaming.

(1) Initial Connection

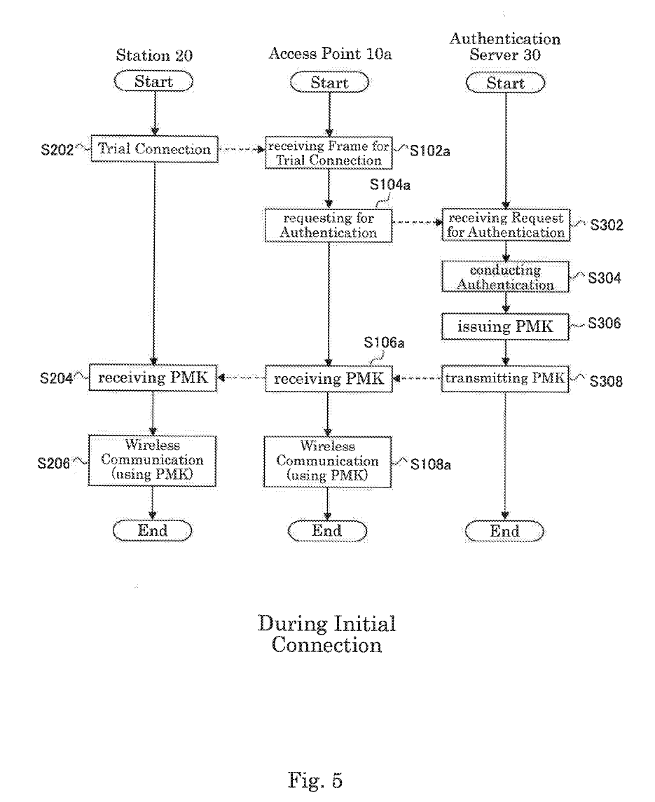

FIG. 5 is a flow chart showing an operation of the wireless LAN system according to the embodiment of the present invention during initial connection. It is noted that FIG. 5 shows the operation separately for each of the wireless LAN station 20, the wireless LAN access point 10a, and the authentication server 30.

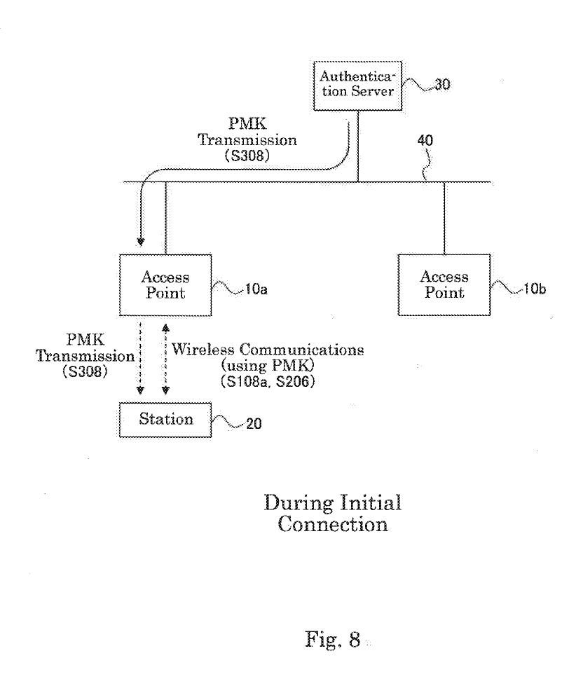

FIG. 8 is a functional block diagram of the wireless LAN system according to the embodiment of the present invention with the operation of the wireless LAN system during the initial connection written therein.

Initial connection means the session during which the wireless LAN station 20 first connects to a wireless LAN access point (wireless LAN access point 10a in this embodiment). The operation during the initial connection is the same as that during the wireless communication using IEEE 802.1x-based authentication.

First, the wireless LAN station 20 tries to connect to a wireless LAN access point (S202).

The terminal communicating section 102a of the wireless LAN access point 10a receives a frame for trial connection transmitted from the wireless LAN station 20 (S102a). The terminal communicating section 102a notifies the authentication requesting section 104a of reception of the frame for trial connection. Upon receiving the notice, the authentication requesting section 104a makes a request to the authentication server 30 for authentication of the wireless LAN station 20 through the LAN cable 40 (S104a).

Upon receiving the request for authentication of the wireless LAN station 20 from the wireless LAN access point 10a (S302), the authentication server 30 conducts authentication (S304), issues a PMK (S306), and transmits the PMK to the wireless LAN access point 10a and the wireless LAN station 20 (S308) (see FIG. 8). It is noted that the authentication (S304), PMK issue (S306), and PMK transmission (S308) are the same as in IEEE 802.1x-based authentication and will not be described in detail.

The PMK receiving section 106a of the wireless LAN access point 10a receives the PMK transmitted from the authentication server 30 through the LAN cable 40 (S106a) and writes it into the PMK recording section 110a. Further, the terminal communicating section 102a reads the PMK out of the PMK recording section 110a and transmits it to the wireless LAN station 20.

The wireless LAN station 20 receives the PMK (S204) and communicates wirelessly with the wireless LAN access point 10a indirectly using the PMK (S206) (see FIG. 8).

The terminal communicating section 102a of the wireless LAN access point 10a also communicates wirelessly with the wireless LAN station 20 indirectly using the PMK (S108a) (see FIG. 8).

(2) PMK Sharing

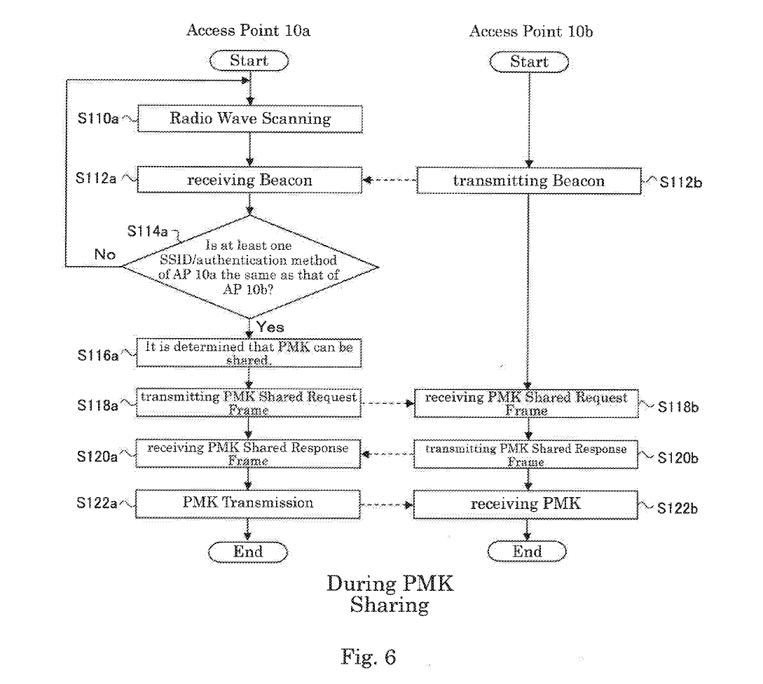

FIG. 6 is a flow chart showing an operation of the wireless LAN system according to the embodiment of the present invention during PMK sharing. It is noted that FIG. 6 shows the operation separately for each of the wireless LAN access point 10a and the proximate wireless LAN access point 10b.

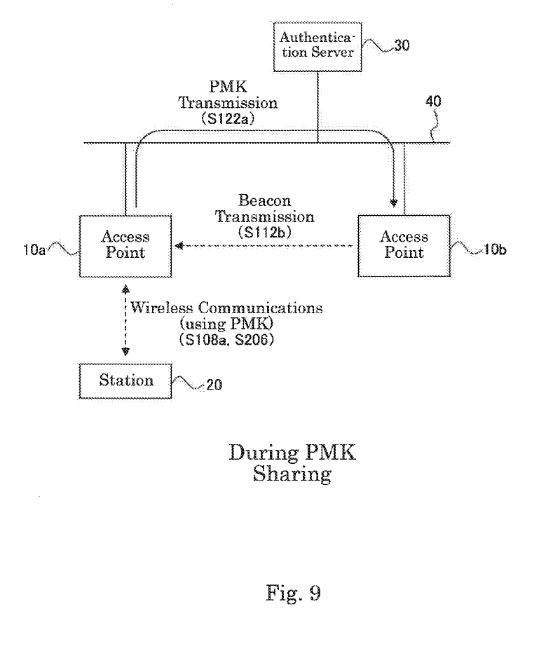

FIG. 9 is a functional block diagram of the wireless LAN system according to the embodiment of the present invention with the operation of the wireless LAN system during the PMK sharing written therein.

The beacon transmitting section 116b of the proximate wireless LAN access point 10b reads an SSID out of the SSID recording section 132b and reads an authentication method out of the security setup recording section 134b. The beacon transmitting section 116b further transmits a beacon with the read SSID and authentication method recorded therein (S112b) (see FIG. 9). In this regard, the wireless LAN access points 10c, 10d, 10e also each transmit a beacon.

The beacon receiving section 118a of the wireless LAN access point 10a performs radio wave scanning (S110a) and receives the beacon from the proximate wireless LAN access point 10b (S112a). In this regard, the beacon receiving section 118a also receives the beacons from the wireless LAN access points 10c, 10d, 10e.

Here, if the received beacon has a strength equal to or greater than a predetermined threshold value, the beacon receiving section 118a determines the wireless LAN access point that has transmitted the beacon as a proximate wireless LAN access point (wireless LAN access point 10b in this embodiment).

The beacon receiving section 118a reads the SSID and the authentication method out of the beacon received from the detected proximate wireless LAN access point 10b and provides them to the PMK shared availability determining section (transmission availability determining section) 120a.

The PMK shared availability determining section 120a reads SSIDs and authentication methods of the wireless LAN access point 10a out of the SSID recording section 132a and the security setup recording section 134a. Further, the PMK shared availability determining section 120a determines whether or not at least one SSID of the wireless LAN access point 10a and an authentication method for use of the SSID and at least one SSID of the proximate wireless LAN access point 10b and an authentication method for use of the SSID are, respectively, the same (S114a). In this regard, the determination is in a simple notation “Is at least one SSID/authentication method of AP 10a the same as that of AP 10b?” in S114a of FIG. 6.

If at least one SSID of the wireless LAN access point 10a and an authentication method for use of the SSID and at least one SSID of the proximate wireless LAN access point 10b and an authentication method for use of the SSID are not, respectively, the same (S114a; No), it is determined that the PMK cannot be transmitted and the routine returns to the radio wave scanning (S110a). In this case, the PMK transmission (S122a) is not performed.

If at least one SSID of the wireless LAN access point 10a and an authentication method for use of the SSID and at least one SSID of the proximate wireless LAN access point 10b and an authentication method for use of the SSID are, respectively, the same (S114a; Yes), the PMK shared availability determining section 120a determines that the PMK can be transmitted (S116a).

The PMK shared request frame transmitting section 114a transmits a PMK shared request frame through the LAN cable 40 to the proximate wireless LAN access point 10b (S118a).

The PMK shared request frame receiving section 115b of the proximate wireless LAN access point 10b receives the PMK shared request frame from the wireless LAN access point 10a (S118b) and notifies the PMK shared response frame transmitting section 113b of the reception.

The PMK shared response frame transmitting section 113b, when receives from the PMK shared request frame receiving section 115b the notice of reception of the PMK shared request frame, transmits a PMK shared response frame through the LAN cable 40 to the wireless LAN access point 10a (S120b).

The PMK shared response frame receiving section 112a of the wireless LAN access point 10a receives the PMK shared response frame from the proximate wireless LAN access point 10b through the LAN cable 40 (S120a) and notifies the PMK transmitting section 108a of the reception of the PMK shared response frame.

The PMK transmitting section 108a transmits a PMK to the proximate wireless LAN access point 10b (S122a) (see FIG. 9).

The PMK receiving section 106b of the proximate wireless LAN access point 10b receives the PMK from the wireless LAN access point 10a through the LAN cable 40 (S122b) and writes it into the PMK recording section 110b.

This causes the wireless LAN access point 10a and the proximate wireless LAN access point 10b to share the PMK. It should be noted that the authentication server 30 is not utilized for this PMK sharing.

(3) Roaming

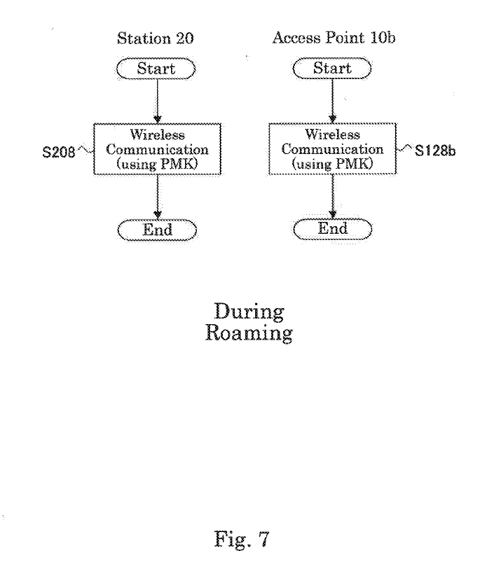

FIG. 7 is a flow chart showing an operation of the wireless LAN system according to the embodiment of the present invention during roaming. It is noted that FIG. 7 shows the operation separately for each of the wireless LAN station 20 and the wireless LAN access point 10b.

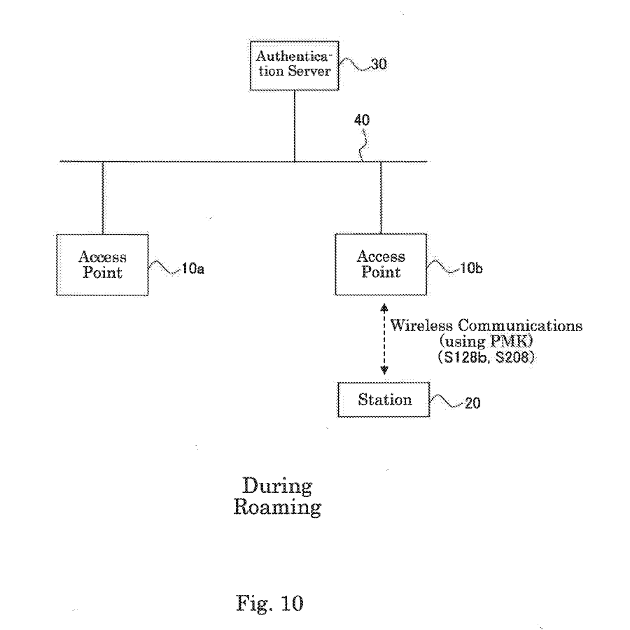

FIG. 10 is a functional block diagram of the wireless LAN system according to the embodiment of the present invention with the operation of the wireless LAN system during the roaming written therein.

It is contemplated that after moving, the wireless LAN station 20 starts communicating (roaming) wirelessly with the proximate wireless LAN access point 10b, which is closer to the wireless LAN access point 10a, in place of the wireless LAN access point 10a.

Hence, the terminal communicating section 102b of the proximate wireless LAN access point 10b communicates wirelessly with the wireless LAN station 20 indirectly using the PMK recorded in the PMK recording section 110b (S128b) (see FIG. 10).

The wireless LAN station 20 also communicates wirelessly with the proximate wireless LAN access point 10b indirectly using the PMK (S208) (see FIG. 10).

It should be noted that the authentication server 30 is not utilized for the roaming.

In accordance with the embodiment of the present invention, when the communication partner of the wireless LAN station 20 is changed from the wireless LAN access point 10a to the proximate wireless LAN access point 10b (roaming), the authentication server 30 neither conducts authentication (see S304 in FIG. 5) nor issues a PMK (see S306 in FIG. 5), whereby high-speed roaming can be achieved.

This is achieved by the wireless LAN access point 10a transmitting a PMK to the proximate wireless LAN access point 10b prior to roaming (see S122a in FIGS. 6 and 9) and the proximate wireless LAN access point 10b records the PMK. In this case, unlike the pre-authentication defined in IEEE 802.11i, the authentication server 30 neither conducts authentication (see S304 in FIG. 5) nor issues a PMK (see S306 in FIG. 5) for the proximate wireless LAN access point 10b, whereby the load on the authentication server 30 can be reduced compared to that for pre-authentication.

The above-described embodiment can also be achieved as follows. A medium (e.g. floppy (registered trademark) disk, CD-ROM) with a program recorded therein that implements the above-described sections (e.g. each section of the wireless LAN access points 10a, 10b) is read by a computer including a CPU, a hard disk, and a medium reader and installed in the hard disk. The above-described functions can be achieved, for example, in this manner.

What is claimed is:

1. A wireless LAN access point that communicates wirelessly with a wireless LAN communication terminal using an encryption key, the wireless LAN access point comprising:
a proximate access point detecting section that detects a proximate wireless LAN access point arranged at a short distance from the wireless LAN access point; and
an encryption key transmitting section that transmits the encryption key to the proximate wireless LAN access point.

2. The wireless LAN access point according to claim 1, wherein the encryption key is used even when the wireless LAN communication terminal starts communicating wirelessly with the proximate wireless LAN access point in place of the wireless LAN access point.

3. The wireless LAN access point according to claim 2, wherein the encryption key is a Pairwise Master Key.

4. The wireless LAN access point according to claim 1, wherein the proximate access point detecting section detects the proximate wireless LAN access point based on a beacon transmitted from another wireless LAN access point.

5. The wireless LAN access point according to claim 1, further comprising a transmission availability determining section that determines whether or not the encryption key transmitting section can transmit the encryption key.

6. The wireless LAN access point according to claim 5, wherein the transmission availability determining section determines that the encryption key can be transmitted if at least one SSID of the wireless LAN access point and an authentication method for use of the at least one SSID and at least one SSID of the proximate wireless LAN access point and an authentication method for use of the at least one SSID are, respectively, the same.

7. The wireless LAN access point according to claim 1, wherein the encryption key transmitting section transmits the encryption key through a LAN cable to the proximate wireless LAN access point.

8. An encryption key sharing method using a wireless LAN access point that communicates wirelessly with a wireless LAN communication terminal using an encryption key, the encryption key sharing method comprising;
a proximate access point detecting step that detects a proximate wireless LAN access point arranged at a short distance from the wireless LAN access point; and
an encryption key transmitting step that transmits the encryption key to the proximate wireless LAN access point.
